(19) United States
(12) Patent Application Publication
(10) Pub. No.: US 2023/0306952 A1
(43) Pub. Date: Sep. 28, 2023

(54) SYSTEMS AND METHODS FOR THROUGH WALL COMMUNICATIONS

(71) Applicant: Eric Haseltine, Rancho Palos Verdes, CA (US)

(72) Inventor: Eric Haseltine, Rancho Palos Verdes, CA (US)

(21) Appl. No.: 18/126,738

(22) Filed: Mar. 27, 2023

Related U.S. Application Data
(60) Provisional application No. 63/324,275, filed on Mar. 28, 2022.

(51) Int. Cl. G10K 11/24; H04R 3/00; H04R 1/08; H04R 1/46; H04R 17/02; H04R 1/02

(52) U.S. Cl. CPC G10K 11/24; H04R 3/00; H04R 1/08; H04R 1/46; H04R 17/02; H04R 1/025

(57) ABSTRACT

A system is provided for communication through or along a barrier. The system includes a transmitter unit for transmitting a signal comprising a transmitter housing, a transmitter fixation element for fixing a first side of the transmitter housing against a barrier, an exciter embedded in or protruding from the first side of the transmitter housing, such that the exciter is applied against the barrier by the fixation element, and an audio input. The transmitter further includes circuitry for driving the exciter based on a signal received at the audio input. The system further includes a receiver unit for receiving a signal comprising a receiver housing, a receiver fixation element for fixing a first side of the receiver housing against the barrier, a vibration sensor for detecting vibrations generated by the exciter, an audio output, and circuitry for driving the audio output based on a signal detected by the vibration sensor.

### CROSS-REFERENCE TO RELATED APPLICATION

This application takes priority from U.S. Provisional Application No. 63/324,275, filed Mar. 28, 2022, the contents of which are incorporated by reference herein in their entirety.

### FIELD OF THE INVENTION

Systems and methods are described for communicating through a wall. In particular, systems and methods are described for voice communications through a wall.

### BACKGROUND

Workers, such as welders and fire preventers operating on opposite sides of metal barriers in closed containers, such as below-deck compartments on ships, need to communicate with each other to perform their work. For example, a fire preventer needs to tell a welder on the opposite side of a bulkhead to stop work if the heat affected zone from welding threatens to cause a fire or damage structures that need to be preserved.

Serious accidents may occur when construction or repair workers cutting or drilling through walls, including metal walls, fail to properly communicate a target cutting location or stop signals. Such workers may penetrate into hazardous areas such as fuel tanks, fuel lines, or electrical lines located on an opposite side of a wall they are cutting or drilling.

Such accidents are a common source of fires, for instance, in the ship repair and building industry where cutting torches applied from one side of a metal partition may inadvertently cut into hazardous areas on the opposite unseen side of the partition (such as a marine bulkhead). Systems and methods for communicating so that parties can prevent or minimize fires and damage are critical.

RF wireless communication, via hand held radios or mobile phones often will not support such communication because the closed metal containers in which the workers are operating effectively block RF signals, acting as a Faraday cage. Thus, workers in such situations often communicate by tapping on the walls, for example agreeing that one tap means “Good to go,” two taps means “Stop work,” and three taps means “FIRE!”.

This crude communication system, though widely used, has severe limitations. For example, ship repair and ship building operations take place in very loud environments due to operation of air compressors and ventilation fans, nail cuts, grinders and other loud machinery. Moreover, due to the hazardous acoustic environment, workers usually are required to wear ear protection that attenuates noise about 30 DB. Therefore, wall taps are not always easy to hear, especially through thick walls (e.g. 2″ thick steel plate). Also, tapping signals convey very limited information that does not permit rich real time communication among work team members.

In many such settings, such as ship repair, it is not feasible to drill small holes to pass wires or fiber optics for wired voice communication (e.g. using an intercom), because of uncertainty of the proximity of those holes to vital structures such as plumbing, fuel lines or electrical lines.

In some confined space environments (e.g. where there is air ducting between compartments), it is possible for workers to hear each other by shouting, but this method cannot be counted on, particularly in noisy environments where workers wear ear protection and where barriers are 12.5 mm thick, or more.

Similarly, through-wall acoustic eavesdropping devices, such as contact microphones or stethoscopes can be used on both sides of a barrier to amplify air-born voice acoustic waves that weakly (due to impedance mismatch between air and solids) propagate through the metal barrier, but noisy environment, coupled with extreme impedance mismatch between air and metal, make use of air-born acoustic waves unreliable.

For all of these reasons, a new means of supporting real time voice communication through metal barriers in enclosed spaces is needed.

### SUMMARY

In some embodiments, a system is provided for communication through or along a barrier. The system includes a transmitter unit for transmitting a signal, the transmitter unit comprising a transmitter housing, a transmitter fixation element for fixing a first side of the transmitter housing against a barrier, an exciter embedded in or protruding from the first side of the transmitter housing, such that the exciter is applied against the barrier by the fixation element, and an audio input. The transmitter further includes circuitry for driving the exciter based on a signal received at the audio input.

The system further includes a receiver unit for receiving a signal, the receiver unit comprising a receiver housing, a receiver fixation element for fixing a first side of the receiver housing against the barrier, a vibration sensor for detecting vibrations generated by the exciter, an audio output, and circuitry for driving the audio output based on a signal detected by the vibration sensor.

In some embodiments, the transmitter unit includes a vibration sensor and an audio output. The receiver unit may then further comprises an exciter and an audio input, such that the transmitter unit and the receiver unit are interchangeable.

In some such embodiments, the circuitry for driving the exciter based on the signal received at the audio input and the circuitry for driving the audio output based on the signal detected by the vibration sensor may be provided on a single chip and duplicated in both the transmitter unit and the receiver unit. The audio input is then connected to the exciter through the circuitry by way of a double pole double throw switch, and the vibration sensor is connected to the audio output through the circuitry by way of the double pole double throw switch.

In some embodiments the vibration sensor is a contact microphone.

In some embodiments, the transmitter fixation element and the receiver fixation element are magnets for fixing their respective housings to the barrier where the barrier is a ferrous material.

In some such embodiments, the magnets are flush with a surface of the first side of the corresponding housing, such that the magnets retain the first side of the corresponding housing against the barrier. In some such embodiments, the transmitter housing further includes an opening through which the exciter extends. The exciter then extends from an interior of the transmitter unit past the surface of the first side of the transmitter housing, and the exciter is compressible towards the surface.

In some such embodiments, the exciter is an electromechanical driver spring loaded such that it is compressed towards the opening by the barrier when the transmitter housing is fixed to the barrier by the magnets.

In some embodiments in which magnets are provided flush with the surface, the receiver housing further comprises an opening through which the vibration sensor extends, and the vibration sensor is a contact microphone. The contact microphone then extends from an interior of the receiver unit past the surface of the first side of the receiver housing, and the contact microphone is compressible towards the surface.

In some such embodiments the contact microphone is a piezo ceramic transducer spring loaded such that it is compressed towards the surface by the barrier when the receiver housing is fixed to the barrier by the magnets.

In some embodiments, the audio input is an audio microphone and the audio output is a speaker or headphones, such that the signal received at the audio input is an audio signal applied to the barrier by vibrating the exciter and wherein the vibration sensor is a contact microphone that retrieves vibrations from the exciter through or along the barrier.

In some such embodiments, the transmitter unit and the receiver unit are fixed to opposite sides of the barrier such that the vibrations are passed through the barrier.

In some other such embodiments, the transmitter unit and the receiver unit are fixed to the same side of the barrier such that the vibrations are passed along the barrier and retrieved from the same side of the barrier.

In some embodiments, the barrier is a bulkhead of a ship.

In some embodiments, each of the transmitter unit and receiver unit further comprise insulation for insulating components of the respective unit from other components of the same unit.

In some embodiments, the transmitter and receiver fixation elements are suction cups or adhesives.

Also provided is a method for transmitting an audio signal through or along a barrier. Such a method may include applying an exciter against a barrier such that the exciter vibrates the barrier when driven and applying a contact microphone of a receiver unit against the barrier at a location different than the exciter. The method then proceeds with receiving, at an audio input of a transmitter unit, an audio signal to be transmitted through the barrier, driving the exciter based on the audio signal received at the audio input, and detecting vibrations in the barrier generated by the exciter using the contact microphone. The method then proceeds with driving an audio output based on the vibrations detected in the barrier.

In some such embodiments, the exciter is at a surface of a first side of the transmitter unit and the contact microphone is at a surface of a first side of the receiver unit. The transmitter and receiver units are fixed to the barrier by respective fixation elements. In some such embodiments, the fixation elements are magnets, suction cups, or adhesives.

In some embodiments, the transmitter unit and the receiver unit are interchangeable. The audio input may then be connected to the exciter by way of a double pole double throw switch, and the contact microphone may be connected to the audio output by way of a double pole double throw switch.

### BRIEF DESCRIPTION OF THE DRAWINGS

FIG. 1 shows an embodiment of a system in accordance with this disclosure.

FIG. 2 shows a second embodiment of a system in accordance with this disclosure.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

Embodiments of a system are provided for allowing real-time voice communication between workers on opposite sides or at a distance along the length of a barrier. Typically, such a system would be used in a confined space, such as within ship compartments, and communication is then through a thick partition, such as a marine bulkhead.

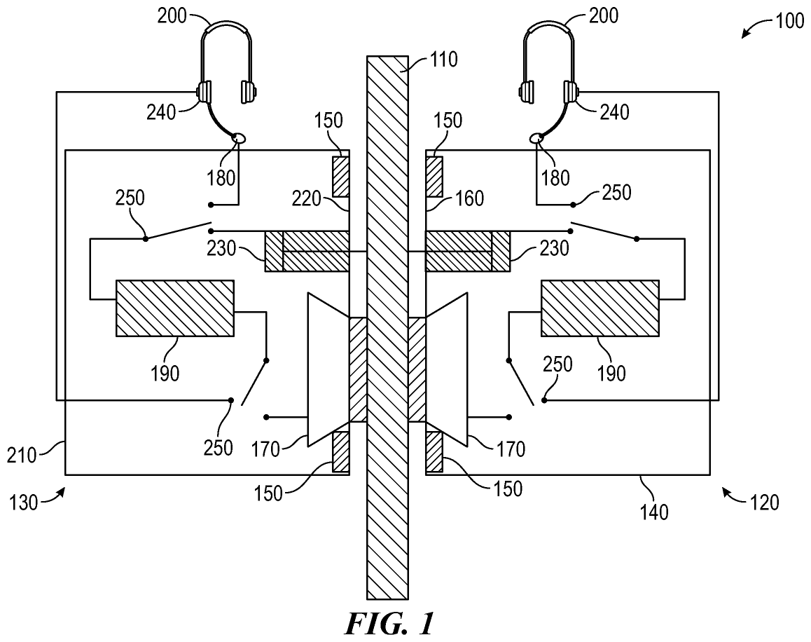

FIG. 1 shows an embodiment of a system 100 in accordance with this disclosure. As shown, such a system is for communication through or along a barrier 110 and includes a transmitter unit 120 and a receiver unit 130. It is noted, and discussed below, that the transmitter unit 120 and receiver unit 130 may each be replaced by a transceiver 120, 130 that can both transmit and receive, and the units may therefore be identical. Such an embodiment is shown in the drawings, such that both the transmitter unit 120 and the receiver unit 130 are identical.

However, in the interest of clarity, and to describe various related embodiment, a transmitter unit 120 may be provided with components necessary for transmission of a signal, such as an audio message while the receiver unit 130 may be provided with components necessary for receiving such a signal transmitted by the transmitter.

Accordingly, parties may be provided with one unit or the other, and in some embodiments, systems may be provided with multiple units of one type or the other, such as when one party is transmitting messages along or through a barrier 110 and multiple parties in different locations, such as different ship compartments are expected to receive such a message.

The transmitter unit 120 may therefore comprise a transmitter housing 140, and a transmitter fixation element 150 for fixing a first side 160 of the transmitter housing 140 against the barrier 110. The transmitter unit 120 may further include an exciter 170 embedded in or protruding from the first side 160 of the transmitter housing 140, such that the exciter is applied against the barrier 110 by the fixation element 150.

The fixation element 150 may be one or a set of several magnets, such that when the barrier 110 is formed form a ferrous material, such as steel, the magnets, which may be permanent magnets mounted flush on the first side 160 of the transmitter housing 140, fix the housing to the barrier. Alternatively, the fixation element 150 may be suction cups or an adhesive, or some other fixation element. In some embodiments, for example, mount locations may be provided on the barrier 110 such that the fixation element 150 can mate with the mount location and firmly locate the transmitter housing 140.

Such a fixation element 150 allows for hands free operation. However, in some environments, such as aluminum barriers or instances where suction or adhesive solutions are not practical, operators can hold and firmly press the transmitter unit 120 against the barrier 110 while communicating.

The exciter 170 is then applied against the barrier 110 such that during use, the exciter vibrates against the barrier, thereby driving a vibration in the wall corresponding to an audio signal. The exciter 170 is generally pressed against the barrier 110 using the force of the fixation element 150. The exciter 170 is typically spring loaded relative to the transmitter housing 140 so that it remains in contact with the barrier 110 during vibrations. For example, the exciter 170 may be an electromechanical driver mounted on a piston or other spring, and may protrude slightly from the transmitter housing 170 when not compressed by the fixation element 150. While the exciter 170 is shown protruding in FIG. 1, it is understood that during use, the first side 160 of the transmitter housing 140 is typically located flush with the barrier 110 by the fixation elements 150, and as such the exciter 170 is compressed into the housing 140 until it is similarly flush with the housing.

A preferred embodiment of the exciter 170 is an electromechanical driver, in which the driver magnetic coil pushes and pulls a bellows with an angular ring that presses directly on the barrier surface, transferring acoustic energy to the barrier directly (instead of through air vibration, as with a standard cone driver). Other embodiments, such as a piezoelectric driver pressed tightly against the barrier, or pressed against the barrier through an impedance matching couplant are feasible.

Accordingly, the transmitter housing 140 includes an opening through which the exciter 170 extends, and the exciter thereby extends form an interior of the transmitter unit 120 past a surface of the first side 160 of the transmitter housing 140, and is then compressible towards the surface.

The transmitter unit 120 further includes an audio input 180 and circuitry 190 for driving the exciter 170 based on a signal received at the audio input. The audio input 180 may be a standard microphone, such as that included in a headset 200 as shown. Alternatively, or in addition, the transmitter unit 120 may include an audio input port, such that any audio input may be provided.

The receiver unit 130 may similarly include a receiver housing 210 and a fixation element 150 similar to that discussed above with respect to the transmitter unit 120. Accordingly, the fixation element 150 may fix a first side 220 of the receiver housing 210 against the barrier 110.

The receiver unit 130 then contains a vibration sensor 230 for detecting vibrations generated by the exciter 170 in the barrier 110, an audio output 240, and circuitry 190 for driving the audio output 240 based on a signal detected by the vibration sensor 230. The circuitry 190 may be similar to or identical to that provided in the transmitter unit 190.

The vibration sensor 230 may be a contact microphone which detects an audio signal applied to the barrier 110 by the exciter 170. As discussed with respect to the exciter, such a contact microphone 230 may be spring loaded relative to the receiver housing 210 so as to maintain contact against the barrier 110.

Accordingly, the receiver housing 210 may have an opening through which the vibration sensor, in this case a contact microphone 230, extends. The contact microphone 230 then extends from an interior of the receiver unit 130 past the surface of the first side 220 of the receiver housing 210. The contact microphone 230 is then compressible towards the surface.

The contact microphone 230 may be a piezo ceramic transducer spring loaded such that it is compressed towards the surface of the first side 220 of the receiver housing 210 by the barrier 110 when the receiver unit 130 is fixed to the barrier 110 by the magnets, or other fixation element 150.

A preferred embodiment of the contact microphone 230 is a piezo ceramic transducer with a spring-loaded piston mounted to the piezo crystal, such that the piston spring is depressed when the receiver housing 210 is pressed against the barrier 110. The piston acts to concentrate mechanical vibration, increasing the pressure per square area on the ceramic, thereby improving sensor sensitivity. Other means, such as direct piezo-barrier contact are also feasible, including the case where an acoustic couplant, such as glycerin or gel is used to match mechanical impedance of the metal barrier to the piezo device.

The audio output 240 may be a speaker or headphones, and may be included in a headset 200, such as that discussed above with respect to a microphone used as an audio input 180. Accordingly, a signal received at the audio input 180 is an audio signal which is applied to the barrier 110 by vibrating the exciter 170. The vibration sensor 230 is then a contact microphone that retrieves vibrations from the exciter 170 through or along the barrier 110.

In some embodiments, the transmitter unit 120 and the receiver unit 130 are fixed to opposite sides of the barrier 110 using the fixation element 150, such that vibrations pass through the barrier.

In some embodiments, the transmitter unit 120 and the receiver unit 130 are fixed to the same side of the barrier 110 and are displaced laterally, such that vibrations are passed along the barrier and retrieved from the same side of the barrier. In some such embodiments, a secondary barrier may extend from the barrier 110 in between the transmitter unit 120 and the receiver unit 130, such that the units may be in different rooms within a ship, for example.

The barrier 110 may be a bulkhead of a ship, as discussed above.

In use, the system described is used for transmitting an audio signal along or through the barrier 110. A method is then provided which includes first applying the exciter 170 against the barrier 110 such that the exciter vibrates the barrier 110 when driven.

A contact microphone 230 of a receiver unit 120 is then applied against the barrier 110 at a location different than the exciter 170. Such a location may be opposite the barrier 110 or laterally displaced along the barrier from the exciter 170.

The method then proceeds with receiving, at the audio input 180 of the transmitter unit 120, an audio signal to be transmitted through the barrier 110.

The exciter 170 is then driven, such as by circuitry 190, based on the audio signal received at the audio input 180. Vibrations in the barrier 110 generated by the exciter 170 are then detected using the contact microphone 230, and the audio output 240 is then driven based on the vibrations detected at the barrier 110.

As discussed above, the transmitter unit 120 and the receiver unit 130 may be identical, and may therefore include identical components. In such an embodiment, the transmitter unit 120 further comprises a vibration sensor 230 and an audio output 240 and the receiver unit 130 further comprises an exciter 170 an audio input 180. The audio input 180 and the audio output 240 may be provided in the context of a headset 200 as shown.

In such an embodiment, the transmitter unit 120 and the receiver unit 130 are interchangeable. The circuitry 190 for driving the exciter 170 based on the signal received at the audio input 180 and the circuitry for driving the audio output 240 based on the signal detected by the vibration sensor 230 may then be provided on a single chip, as shown, and duplicated in both the transmitter unit 120 and the receiver unit 130. The audio input 180 may then be connected to the exciter 170 through the circuitry 190 by way of a double pole double throw (DPDT) switch 250. The vibration sensor 230 is then also connected to the audio output 240 through the circuitry 190 by way of the double pole double throw switch 250. Such a switch 250 may be a mechanical relay or a semiconductor transmit/receive switch.

Such a switch 250 may be directly operated mechanically, or through activation of an electromechanical relay or solid state transmit/receive switch. In some embodiments, audio signals may be detectable, such that if a user of the transmitter unit 120 speaks into the audio input 180, the switch 150 configures automatically for transmission. Similarly, if audio signals are detected at a vibration sensor 170, the corresponding switch 250 automatically configures for receipt and output of a signal.

It is understood that the switch 250 may be viewed as a single double pole double throw (DPDT) switch or as two discrete switches, and that the switch or switches are shown schematically in the drawing. As such, the open and closed configurations shown do not necessarily reflect the status of a unit shown as a transmitter unit 120 or a receiver unit 130.

The circuitry 190 provided on the single chip may then include a two-stage amplifier, including a microphone pre-amplifier feeding an audio power amplifier. The switch 250 described may then function in the transmitter unit 120 to relay signals from the audio input 180 to the circuitry 190 and from the circuitry to the exciter 170. The switch 250 may function in the receiver unit 130 to relay signals sensed by the contact microphone 230 after propagating through the barrier 110 to the circuitry 190 and to the audio output 240.

As noted above, headsets 200 are often used in such environments over ear protection. As such, the power of the two-stage amplifier in the circuitry 190 is typically sufficient such that amplified voice signal in the audio output 240, such as headphones, are loud enough to be distinctly heard through attenuation applied by the ear protection. Accordingly, if the ear protection provides 30 DB of attenuation, the audio output 240 may be amplified so as to provide approximately 80 DB SPL so that it can be distinctly heard through the attenuation, but would not cause hearing damage if used without such attenuation. Such audio output may be adjustable.

A preferred embodiment of the headphone drivers to overcome the approximately 30 DB of hearing protection are cone type drivers, although other means of overcoming sound attenuation, such as bone conduction earphones that bypass ear canal attenuators are feasible.

As a preferred embodiment of the vibration sensor 230 is a piezoelectric transducer with high electrical output impedance, a preferred embodiment of the pre-amplifier stage of the two-stage amplifier used in the circuitry 190 is a high input impedance (>100 K ohm) stage, such as provided by an OP amp or FET with high input impedance and high gain (>20 DB). Because the barrier sensor 230 and headset microphone 180 share the same pre-amplifier, a preferred embodiment for the headset microphone is a high output impedance transducer, such as electret microphone.

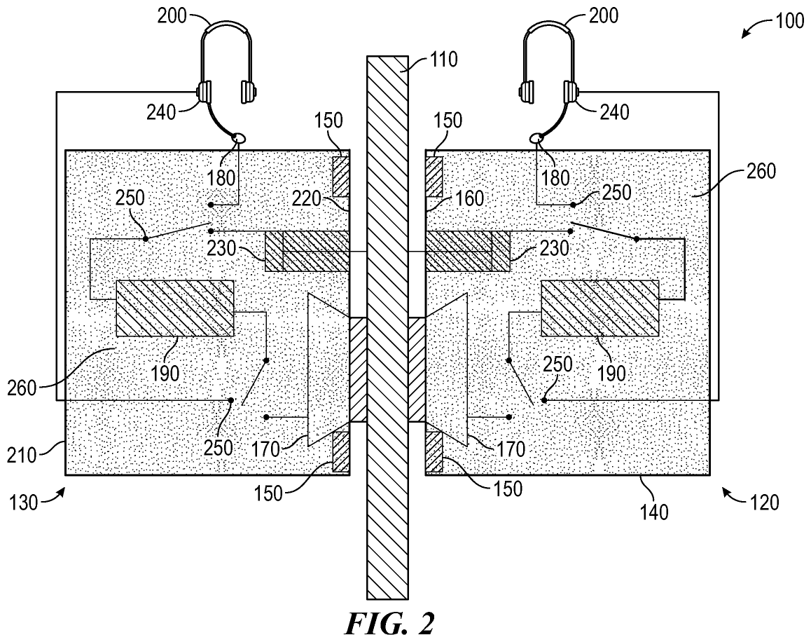

FIG. 2 shows a second embodiment of a system 100 in accordance with this disclosure. The second embodiment shown is similar in most respects to that discussed above, and as such similar reference numerals are used where similar elements are provided.

Due to the high gain of the two-stage amplifier of the circuitry 190, and sensitivity of the voice microphone used as the audio input 180, care must be taken to damp out distortion-provoking positive feedback loops between the voice microphone and exciter during voice transmission. A preferred embodiment to damp out such feedback is to pack the transceiver enclosures with light-weight acoustic foam 260 (such as used in ear protection plugs) to attenuate back radiation of sound from the exciter 170 into the compartment where the speaker is operating, as shown in FIG. 2.

Lightweight foam may be preferred because it minimally increases the weight of the transmitter and receiver housings 140, 210 (thereby making the task of attaching the enclosure to the barrier easier).

However, other sound batting material such as dense acoustic absorbing fibers are feasible.

Moreover, active feedback suppression systems, such as adaptive filter systems used in public address systems, are also feasible.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A system for communication through or along a barrier comprising:
a transmitter unit for transmitting a signal, the transmitter unit comprising:
a transmitter housing;
a transmitter fixation element for fixing a first side of the transmitter housing against a barrier;
an exciter embedded in or protruding from the first side of the transmitter housing, such that the exciter is applied against the barrier by the fixation element;
an audio input;
circuitry for driving the exciter based on a signal received at the audio input;
a receiver unit for receiving a signal, the receiver unit comprising:
a receiver housing;
a receiver fixation element for fixing a first side of the receiver housing against the barrier;
a vibration sensor for detecting vibrations generated by the exciter;
an audio output; and
circuitry for driving the audio output based on a signal detected by the vibration sensor.

2. The system of claim 1, wherein the transmitter unit further comprises a vibration sensor and an audio output, and wherein the receiver unit further comprises an exciter and an audio input, such that the transmitter unit and the receiver unit are interchangeable.

3. The system of claim 2, wherein the circuitry for driving the exciter based on the signal received at the audio input and the circuitry for driving the audio output based on the signal detected by the vibration sensor is provided on a single chip and duplicated in both the transmitter unit and the receiver unit, and wherein the audio input is connected to the exciter through the circuitry by way of a double pole double throw switch, and wherein the vibration sensor is connected to the audio output through the circuitry by way of the double pole double throw switch.

4. The system of claim 1, wherein the vibration sensor is a contact microphone.

5. The system of claim 1, wherein the transmitter fixation element and the receiver fixation element are magnets for fixing their respective housings to the barrier where the barrier is a ferrous material.

6. The system of claim 5, wherein the magnets are flush with a surface of the first side of the corresponding housing, such that the magnets retain the first side of the corresponding housing against the barrier.

7. The system of claim 6, wherein the transmitter housing further comprises an opening through which the exciter extends, and wherein the exciter extends from an interior of the transmitter unit past the surface of the first side of the transmitter housing, and wherein the exciter is compressible towards the surface.

8. The system of claim 7, wherein the exciter is an electromechanical driver spring loaded such that it is compressed towards the opening by the barrier when the transmitter housing is fixed to the barrier by the magnets.

9. The system of claim 6, wherein the receiver housing further comprises an opening through which the vibration sensor extends, and wherein the vibration sensor is a contact microphone, and wherein the contact microphone extends from an interior of the receiver unit past the surface of the first side of the receiver housing, and wherein the contact microphone is compressible towards the surface.

10. The system of claim 9, wherein the contact microphone is a piezo ceramic transducer spring loaded such that it is compressed towards the surface by the barrier when the receiver housing is fixed to the barrier by the magnets.

11. The system of claim 1, wherein the audio input is an audio microphone and wherein the audio output is a speaker or headphones, such that the signal received at the audio input is an audio signal applied to the barrier by vibrating the exciter and wherein the vibration sensor is a contact microphone that retrieves vibrations from the exciter through or along the barrier.

12. The system of claim 11 wherein the transmitter unit and the receiver unit are fixed to opposite sides of the barrier such that the vibrations are passed through the barrier.

13. The system of claim 11 wherein the transmitter unit and the receiver unit are fixed to the same side of the barrier such that the vibrations are passed along the barrier and retrieved from the same side of the barrier.

14. The system of claim 1 wherein the barrier is a bulkhead of a ship.

15. The system of claim 1 wherein each of the transmitter unit and receiver unit further comprise insulation for insulating components of the respective unit from other components of the same unit.

16. The system of claim 1 wherein the transmitter and receiver fixation elements are suction cups or adhesives.

17. A method for transmitting an audio signal through or along a barrier comprising:
applying an exciter against a barrier such that the exciter vibrates the barrier when driven;
applying a contact microphone of a receiver unit against the barrier at a location different than the exciter;
receiving, at an audio input of a transmitter unit, an audio signal to be transmitted through the barrier;
driving the exciter based on the audio signal received at the audio input;
detecting vibrations in the barrier generated by the exciter using the contact microphone;
driving an audio output based on the vibrations detected in the barrier.

18. The method of claim 17 wherein the exciter is at a surface of a first side of the transmitter unit and wherein the contact microphone is at a surface of a first side of the receiver unit, and wherein the transmitter and receiver units are fixed to the barrier by respective fixation elements.

19. The method of claim 18, wherein the fixation elements are magnets, suction cups, or adhesives.

20. The method of claim 17 wherein the transmitter unit and the receiver unit are interchangeable, and wherein the audio input is connected to the exciter by way of a double pole double throw switch, and wherein the contact microphone is connected to the audio output by way of a double pole double throw switch.
